(19) United States
(12) Patent Application Publication
(10) Pub. No.: US 2007/0150441 A1
(43) Pub. Date: Jun. 28, 2007

(54) METHODS, SYSTEMS, AND COMPUTER PROGRAM PRODUCTS FOR ASSOCIATING POLICIES WITH TUPLES USING A PUB/SUB PROTOCOL

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/306,341

(22) Filed: Dec. 23, 2005

(51) Int. Cl. G06F 17/30

(52) U.S. Cl. 707/3

(57) ABSTRACT

Methods, systems, and computer program products are disclosed for associating policies with tuples using a pub/sub protocol. A tuple is subscribed to for receiving a notification when the tuple is updated. A policy tuple is associated with the subscription to the tuple. The policy tuple identifies an action associated with the tuple update. In response to receiving the notification, the action is initiated. In one embodiment, a notify message indicating the associated action is generated and sent using a pub/sub protocol to a policy enforcer for performing the associated action.

### RELATED APPLICATIONS

This application is related to copending U.S. application Ser. No. 10/960,365, filed Oct. 6, 2004, entitled “System and Method for Utilizing Contact Information, Presence Information and Device Activity” and to copending U.S. application Ser. No. 10/960,135, filed Oct. 6, 2004, entitled “System and Method for Utilizing Contact Information, Presence Information and Device Activity,” the contents of both of which are incorporated by reference here in their entirety.

### TECHNICAL FIELD

The subject matter described herein relates to policy management. More particularly, the subject matter described herein relates to associating policies with tuples using a pub/sub protocol.

### BACKGROUND

Publish/subscribe (pub/sub) services, such as presence services, typically store and organize information into portions referred to as tuples. A tuple, in its broadest sense, is a data object containing one or more elements. For example, information can be stored in presence tuples. Presence tuples include the status of a principal of a presence service, but can also include additional information, such as contact information and other information.

A number of methods have been described that make use of policies to automate the carrying out of actions when a tuple is updated. Some involve an entity that watches tuples for a condition and integrates its own policies for managing the tuple. Specification and management of these policies is often not revealed or is specific to the watching entity. In addition, the policies typically require the use of specific (non-pub/sub) protocols to manage the policies (in addition to a pub/sub protocol to update the tuples). Since the watching entities are typically decentralized, there is also no system or method for centrally managing tuple policy enforcement and automation in addition to the lack of a common mechanism for communicating with the policy/automation watchers for the purpose of managing the policies and associated actions.

For example, United States Published Patent Application No. 2004/0225717 to Cuervo relates to a system where messaging servers are used to communicate between a policy server and policy managers. The policies are stored in a policy repository accessible from the policy server and policy evaluation is performed on the policy server. A policy client is used to communicate with the policy server to manage the policies on the policy server. The policy information is included in the logic that carries out policy enforcement. Thus, policy parsing and evaluation are performed as a part of the policy enforcement function. All conditions/rules, interpreters, and actions are tightly bound making changes difficult, more prone to bugs, and unmanageable in any unified way. In addition, other non-pub/sub protocols are required to carry out policy management.

Accordingly, there exists a need for methods, systems, and computer program products for associating policies with tuples using a pub/sub protocol.

### SUMMARY

In one aspect of the subject matter disclosed herein, a method for associating policies with tuples using a pub/sub protocol includes subscribing to a tuple for receiving a notification when the tuple is updated and associating a policy tuple with the subscription to the tuple. The policy tuple identifies an action associated with the tuple update. Responsive to receiving the notification: a notify message indicating the associated action is generated and is sent using a pub/sub protocol to a policy enforcer for performing the associated action.

In another aspect of the subject matter disclosed herein, a method for associating policies with tuples using a pub/sub protocol includes receiving a policy specification using a pub/sub protocol, where the policy specification specifies a tuple, a condition associated with the specified tuple, and an action associated with the condition. The method also includes storing the policy specification in at least one of the specified tuple and another tuple, determining when the condition associated with the specified tuple is met, and responsive to determining that the condition is met, invoking the action.

In another aspect of the subject matter disclosed herein, a system for associating policies with tuples using a pub/sub protocol includes: means for storing a policy specification as a policy tuple that specifies a tuple, a condition associated with the specified tuple, and an action associated with the condition; means for subscribing to the tuple for receiving a notification when the tuple is updated, for associating the policy tuple with the subscription to the tuple, and for determining if the tuple update satisfies the condition associated with the tuple based on the tuple update notification; and means for generating, responsive to receiving the notification, a notify message indicating the associated action and for sending the notify message using a pub/sub protocol to a policy enforcer for performing the associated action.

In another aspect of the subject matter disclosed herein, a system for associating policies with tuples using a pub/sub protocol includes: a policy tuple manager configured for storing a policy specification as a policy tuple that specifies a tuple, a condition associated with the specified tuple, and an action associated with the condition; a policy watcher configured for subscribing to the tuple for receiving a notification when the tuple is updated, for associating the policy tuple with the subscription to the tuple, and for determining if the tuple update satisfies the condition associated with the tuple based on the tuple update notification; and a policy action initiator configured for generating, responsive to receiving the notification, a notify message indicating the associated action and for sending the notify message using a pub/sub protocol to a policy enforcer for performing the associated action.

In another aspect of the subject matter disclosed herein, a system for associating policies with tuples using a pub/sub protocol includes: means for receiving a policy specification using a pub/sub protocol and for storing the policy specification as a policy tuple that specifies a tuple, a condition associated with the specified tuple, and an action associated with the condition; means for determining when the condition associated with the specified tuple is met; and means for invoking the associated action.

In another aspect of the subject matter disclosed herein, a system for associating policies with tuples using a pub/sub protocol includes: a policy tuple manager configured for receiving a policy specification using a pub/sub protocol and for storing the policy specification as a policy tuple that specifies a tuple, a condition associated with the specified tuple, and an action associated with the condition; a policy watcher configured for determining when the condition associated with the specified tuple is met; and a policy action initiator configured for invoking the associated action.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a system for associating policies with tuples using a pub/sub protocol according to one aspect of the subject matter disclosed herein;

FIG. 2 illustrates an exemplary policy tuple;

FIG. 3 is a block diagram illustrating a system for associating policies with tuples using a pub/sub protocol according to another aspect of the subject matter disclosed;

FIG. 4 is a block diagram illustrating a system for associating policies with tuples using a pub/sub protocol according to another aspect of the subject matter disclosed;

FIG. 5 is a flow diagram illustrating a method for associating policies with tuples using a pub/sub protocol according to an aspect of the subject matter disclosed herein; and

FIG. 6 is a flow diagram illustrating a method for associating policies with tuples using a pub/sub protocol according to another aspect of the subject matter disclosed herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

According to aspects of the subject matter disclosed herein, a pub/sub protocol may be used to communicate between two or more other entities for some or all of the communications described. Generally, in a pub/sub protocol, senders of information (or publishers) post (or publish) messages with specific topics rather than sending messages to specific recipients. The pub/sub messaging system then selectively broadcasts the posted messages (through what are referred to as notify messages) to all interested parties, referred to as subscribers. The published information can be read simultaneously by any number of subscribing clients.

By way of example, aspects of the subject matter described here can employ a presence protocol as the pub/sub communications protocol. It should be understood, however, the relevant techniques described here can be performed using any pub/sub communications protocol. Additionally, the subject matter described herein is not limited to the use of a pub/sub protocol for all communications described. Other known protocol can also be used. Presence information can be used by using a presence protocol and providing presence services. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society.

Generally speaking, one or more pub/sub servers are used to provide pub/sub services. The function of a pub/sub server, however, can be incorporated, either in whole or in part, into other entities. For example, the presence service model can be used. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from a presence service on behalf of a presence client. The presence model of RFC 2778 describes two types of watchers, referred to as “subscribers” and “fetchers”. A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher. A special kind of fetcher, referred to as a “poller”, is defined in the model that fetches information on a regular (or polling) basis.

The presence service can also manage, store, and distribute presence information associated with watcher clients through their presentities, as well as the watcher clients' activities in terms of the fetching or subscribing to the presence information of other presence clients using the presence service. This “watcher activity information” can be distributed to other watcher clients by the presence service using the same mechanisms that are available for distributing the presence information of presentity clients.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

It should also be understood that, as used herein, the term “presence information” can include any information associated with a service requester. In the presence model RFC 2778, status is defined as a distinguished part of presence information of a presentity. More particularly, RFC 2778 defines statuses of open and closed for use in instant messaging and other forms of communication. A status of open, for example, can indicate availability to receive communications (such as IM messages and can include any other forms of communications), while closed can be used to indicate unavailability. RFC 2778 also provides for status to include other values, which can consist of single or multiple values. Status can be very specific or broad. For example, status can include enabled and disabled as applied to a policy or rule. Accordingly, status can include forms and values not specifically mentioned in the presence model while omitting forms and values that are specifically mentioned, while staying within the model described in RFC 2778. It should therefore be understood that presence information, as used herein, is intended to cover all forms and values of status specifically mentioned in RFC 2778 and those not specifically mentioned.

As mentioned above, a pub/sub (or presence) service typically stores and organizes information into tuples. For example, although not required, the information can be stored in presence tuples. Presence tuples include the status of a principal of a presence service, but can also include additional information. It should be understood, therefore, that presence information can contain multiple status values that can be broad indicators and/or precise indicators of presence.

According to aspects of the subject matter disclosed herein, policy specifications, including conditions and actions can be stored as tuple data in “policy tuples” and can therefore be managed using a pub/sub protocol. That is, the policies can be created, deleted, stored, and updated like any other tuple data using pub/sub protocols. Further, the policies may be separated from the components which perform actions, thus allowing for a very flexible system where condition to action mappings can be changed merely by updating the policy tuple.

The policies can be enforced by a policy enforcer at the pub/sub service or by one or more distributed policy enforcers that receive messages indicating that an action is necessary. Since the policies are stored as tuple data, the services of a pub/sub service can be used in the implementation, management, and/or enforcement of the policies. These services include security (authentication, authorization, and privacy (e.g., encryption)), account management, storage, protocols, and the like.

Policy tuples may include policy specifications that apply to a specific tuple as well as to groups of tuples that meet some specified conditions. In an alternate embodiment, policy tuples may be associated with tuples via a roster list, or other type of grouping structure or method. In addition, the policy specifications can apply to other policy tuples and/or can be stored as part of the tuple (e.g., a subtuple) the policy specification is associated with, resulting in self-managing tuples.

The term “policy,” as used herein, includes a specified condition that when met can result in a specified action being performed. The use of policy tuples enables automated actions that can be managed using pub/sub protocols. Additionally, policy tuples enable conditions and actions to be created, managed, and deployed separately resulting in a system which provides a common system for the creation and management of automated policy enforcers, and also providing a more flexible system in that the association of an action with a condition is accomplished through the publishing of tuple data. Any available action may be associated with any specifiable condition using a policy tuple. A hierarchy of policy tuples can be created for individual tuples, groups of tuples, and super groups of tuples. The policy at the lowest level can override the policy(s) at the higher levels. This allows default policies to be established for groups of tuples and refined for subgroups down to the level of a single tuple. Alternatively, multiple unrelated policies can be applied to the same tuple or group (e.g., analogous to multiple inheritance in object oriented programming). The policies can also provide different schemes for determining when one policy overrides another for handling policy conflicts or overlaps.

Several examples of policies that may be implemented are discussed below:

A policy may be established that specifies that a piece of presence data, such as the status “In a meeting,” is only valid for 1 hour. At the end of the hour, the status can be changed to some specified value and the owner can be sent a message asking that the new status be provided by the action handler.

Some tuple data may be short-lived, such as data that makes a request of another entity or provides a response. A policy may be provided that indicates that the data is to be deleted as soon as the target entity receives it (or some specified time period thereafter), to delete the data if it is not received within a certain time period, if it appears that unauthorized entities are attempting to access the data, or when a status value is set to a value from a specified set.

In a project schedule tuple, when a milestone date is reached, a policy tuple may specify that the current status changes to “past due” or some similar status until an authorized entity explicitly updates the tuple to reflect the actual status.

Policy tuples may be used to implement work-flow processes.

Policy tuples may be used to monitor activity of a resource through its tuple. Based on the policies the resource may be managed either by directly invoking actions on the resource or by updating a tuple that the resource is subscribed to. The tuple updates trigger actions on the resource.

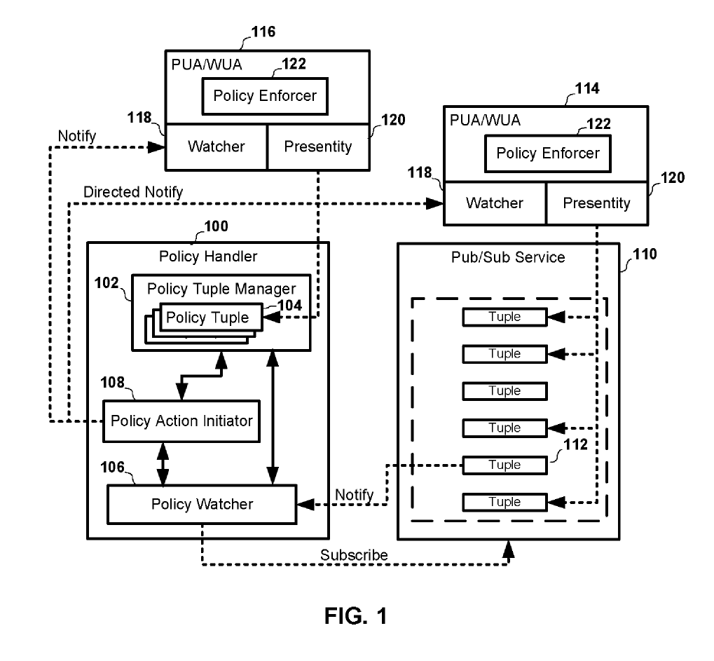

FIG. 1 is a block diagram illustrating a system for associating policies with tuples using a pub/sub protocol according to one aspect of the subject matter disclosed herein. The system includes a policy handler 100. The policy handler 100 includes means for storing a policy specification as a policy tuple. For example, a policy tuple manager 102 can be configured for storing the policy specification as one or more policy tuples 104. The policy specification specifies a tuple, a condition associated with the specified tuple, and an action associated with the condition, as will be discussed further below. The policy tuple manager 102 can include a memory for storing the policy tuples 104 or can access an external memory or database that stores the policy tuples 104.

Policy handler 100 also includes means for subscribing to the tuple for receiving a notification when the tuple is updated, for associating the policy tuple with the subscription to the tuple, and for determining if the tuple update satisfies the condition associated with the tuple based on the tuple update notification. For example, a policy watcher 106 can be configured for performing these functions.

Policy handler 100 also includes means for generating, responsive to receiving the notification, a notify message indicating the associated action and for sending the notify message using a pub/sub protocol to a policy enforcer for performing the associated action. For example, a policy action initiator 108 can be configured for performing these functions.

Also shown in FIG. 1 is a pub/sub service 110 (such as a presence service). According to one implementation, the policy handler 100 may be part of or associated with the pub/sub service 110. The pub/sub service 110 includes one or more tuples 112. The policy watcher 106 can include a watcher that subscribes to one or more tuples 112 at the pub/sub service 110. The policy watcher can be configured for subscribing to the one or more tuples 112 using a pub/sub protocol. When the tuple 112 is updated, a notify message is received from the tuple 112 at policy watcher 106. The policy watcher 106 can also be configured to communicate with the policy tuple manager 104 to determine if the tuple update satisfies the condition specified in policy tuple 104 based on the tuple update notification.

Also shown in FIG. 1 are presence/watcher user agents (PUA/WUA) 114, 116 that can each include a watcher 118, a presentity 120, and a policy enforcer 122. Presence/watcher user agent 114 is associated with the pub/sub service 110 such that the corresponding presentity 120 is configured to update one or more tuples 112 in the pub/sub service 110.

The policy action initiator 108 can be configured to generate and send a notify message to a policy enforcer 122 using a pub/sub protocol in response to receiving the notification at the policy watcher 106. For example, the policy action initiator 108 can generate and send a notify message to a policy enforcer 122 indicating the associated action. As shown in FIG. 1, the notify message can be sent pursuant to a subscription by a watcher 118 to the policy tuple 104 and/or can be a directed notify that is sent to a specific watcher 118 without requiring a subscription to the policy tuple 104 by the watcher 118. Also as shown in FIG. 1, the policy tuple 104 can be updated by presentity 120 to update the policy specification.

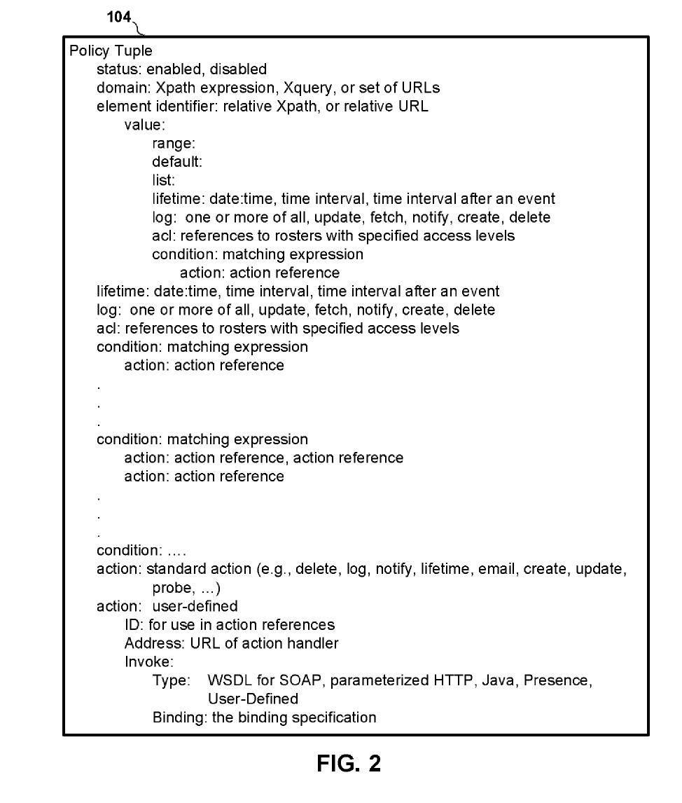

The policy tuple 104 is a data tuple that specifies various states, conditions, and/or events related to one or more associated tuple(s), which can specify the enforcement of one or more actions in response to the states, conditions, and/or events. An exemplary policy tuple 104 is illustrated in FIG. 2. The policy tuple 104 can include several elements. It should be understood that not all of the elements illustrated in FIG. 2 are necessarily required. The example given in FIG. 2 includes the following elements as examples of possible policy tuple content:
Status: The status element indicates the active status of the policy. Inclusion of the status element provides a “status” for the tuple, which can thus be considered a presence tuple. In the example, the policy is either “enabled”/“active” or “disabled”/“inactive.” When the status is “enabled,” the policy tuple manager 102 instructs the policy watcher 106 to watch the associated tuple or tuples as identified by the domain element (see below). When the status is “disabled,” the policy tuple is not applied.
Domain: The domain element specifies the associated tuple or tuples that are watched by the policy watcher 106. The domain may specify, for example, a tuple identifier, a uniform resource indicator (URI), an extensible markup language (XML) PATH (XPath) expression if the tuples are represented in XML, an XML query language (XQuery) query, a structured query language (SQL query), or another expression. The domain may contain a combination of identification mechanisms for specifying the tuples for which the policy applies. In one implementation, the associated tuple may be indicated by a matching condition or by a list or roster.
Element Identifier: A policy tuple may contain one or more element identifiers. An element identifier contains one or more identifiers of tuple elements in the watched tuples for which it applies. As with the domain, the element identifier(s) may be specified in a number of ways, such as a relative XPath or URI, or another expression. Element identifiers can have subtuples with subelements that specify policies for the watched tuple elements for which they apply. Exemplary subelements include:
   Range: The range subelement can specify valid values that the watched elements may be assigned using a range;
   List: The list subelement can specify valid values that the watched elements may be assigned using a list;
   Default: The default subelement can specify a default value to assign in cases where the watched element has not been assigned a value;
   Lifetime: The lifetime subelement can specify the lifetime of the watched element (e.g., indicating when it should be deleted) specified as a specific date and time, an interval, an interval after the occurrence of an identified event or events, etc.;
   Log: The log sub element can specify what events to log associated with the element;
   ACL: The access control list (ACL) subelement can specify permissions associated with the element and can be used by the policy tuple manager 102 to enforce those permissions; and
   Condition: The condition subelement can specify a matching expression related to a characteristic of the watched element. If the matching expression is true when a notification is received, the action(s) specified by this subelement are invoked.
In addition, as shown in FIG. 2, the watched tuple(s) as a whole may also have lifetime, log, ACL, and condition elements associated with them, similar to their watched elements.

The specified actions can include standard actions known to both the policy handler 100 and the policy enforcer 122 by including, for example, an action identifier. The action can then be invoked by the policy action initiator 108 by providing the action identifier to the policy enforcer 122. Examples of standard actions include delete, log, notify, lifetime, email, create, update, probe, and the like. Standard actions may be provided by the policy handler 100 or the pub/sub service 110 and may be invoked by a local or remote procedure call. In alternate embodiments, standard actions may be invoked by policy enforcers 122 via the transmission of notify commands. The specified actions can also include user-defined actions that are defined by a user via a user interface (not shown) for accessing the policy handler 100. User-defined actions can include an identifier for the action and a locator, such as URI, for enabling the policy action initiator 108 to invoke the action.

Actions can conform to a predefined interface known to the policy action initiator 108 or may include bind information for providing the policy action initiator 108 with knowledge of how to invoke or call the action. Bind information allows the system to support actions that may not otherwise support pub/sub notifications. It should be appreciated that an action may specify operations on a tuple or tuples or other operations not directly affecting tuples, such as sending an e-mail. Actions may be specified to be invoked serially or in parallel or a combination of the two.

Generally speaking, anything that can be done with a watcher or watcher/presentity pair can be done by policy handler 100 with a policy tuple 104. This allows the policy handler 100 to manage subscriptions for any number of watchers, thus providing a flexible and efficient mechanism for policy management.

In another possible implementation, the policy handler 100 can include a scripting engine like Jelly. Jelly allows executable code to be associated with XML tags. That is, when an XML parser detects a tag, a routine is called associated with the tag and its contents. This allows users to write their own condition elements and action elements. For example, the detection of a specific element value may result directly in the invocation of its associated action. Ant is another example of an XML configuration language where elements are associated with actions. Ant is extendable. Note that with Ant and Jelly an entire XML document can be executed when a specified condition is met.

Returning to FIG. 1, the policy tuple manager 102 can be configured to store the policy specification as, for example, a presence tuple and/or as a subtuple of the watched tuple 112. Also, the watched tuple 112 can be a policy tuple 104. According to one aspect, the policy tuple 104 can be stored at the pub/sub service 110.

The policy action initiator 108 can be configured to generate a notify message that includes an action identifier for the associated action. An action identifier could be, for example, delete, log, notify, lifetime, email, create, update, probe, and the like, as discussed above. Alternatively, or in addition, the policy action initiator 108 can configured for generating a notify message that identifies the policy enforcer 122 for performing the associated action. For example, a URI or other addressing mechanism used for locating a policy enforcer 122 may be all that is needed where the policy enforcer 122 is configured to carry out the action needed by default and therefore does not need to have the action specified. In each case, the policy tuple 104 is parsed at the policy handler 110.

According to another aspect, the policy action initiator 108 can send a notify message that includes all or a substantial portion of the policy tuple 104 and the policy tuple can be parsed by policy enforcer 122. The policy enforcer 122 parses and interprets the policy tuple and only invokes actions that are required by the policy.

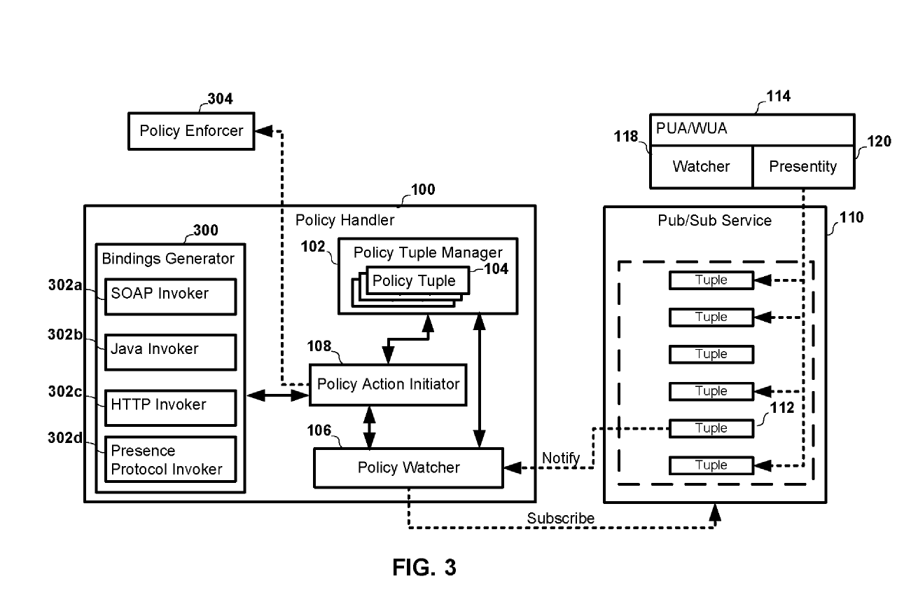

According to another aspect, the policy action initiator is configured for generating a notify message that identifies binding-related information for invoking the associated action. With reference to FIG. 3, the policy handler 100 can include a bindings generator 300 to allow actions to be used which are invoked through means other than by using a pub/sub protocol. The bindings generator 300 can include one or more invoker components 302a-d that are each associated with a particular protocol or language. The invoker components 302a-d shown in FIG. 3 include a simple object access protocol (SOAP) invoker, a Java invoker, a hypertext transfer protocol (HTTP) invoker, and a presence protocol invoker. When the policy action initiator 108 initiates an action, it reads associated bind information from the policy tuple 104 and provides the bind information to the bindings generator 300. The bindings generator 300 can then provide binding-related information for invoking a policy enforcer 304. For example, the bindings generator 300 can provide program code for binding, referred to as a binding stub, to the policy enforcer 304. The binding-related information can then be provided to the policy enforcer 304 for performing an action. Note that the communications with the policy enforcer 304 can be carried out using a protocol associated with the binding-related information or using a pub/sub protocol.

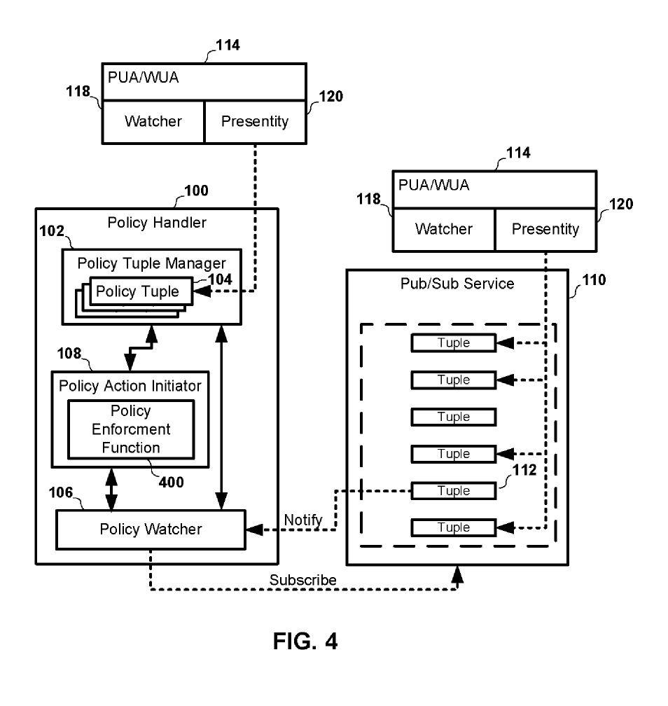

FIG. 4 is a block diagram illustrating a system for associating policies with tuples using a pub/sub protocol according to another aspect of the subject matter disclosed. In FIG. 4, the policy handler 100 includes means for receiving a policy specification using a pub/sub protocol and for storing the policy specification as a policy tuple 104 that specifies a tuple, a condition associated with the specified tuple, and an action associated with the condition. For example, the policy tuple manager 102 can be configured for receiving a policy specification using a pub/sub protocol via a presentity 120 at a presentity user agent 114. Here, the term “receiving” includes receiving information for creating new policy tuples and/or for updating existing policy tuples, which can include the deletion of existing policy tuples.

The policy tuple manager 102 can also be configured for storing the policy specification as a policy tuple 104 that specifies a tuple 112, a condition associated with the specified tuple 112, and an action associated with the condition. According to one aspect, the policy tuple manager 102 can be configured for storing the policy specification as a policy tuple 104 that specifies a presence tuple, a condition associated with the presence tuple, and an action associated with the condition. According to another aspect, the policy tuple manager 102 can be configured for storing the policy specification as a policy tuple 104 that specifies another policy tuple, a condition associated with the other policy tuple, and an action associated with the condition. In another aspect, the policy tuple manager 102 can be configured for storing the policy specification in a subtuple of the specified tuple 112. In yet another aspect, the policy tuple manager 102 can be configured for storing the policy specification as a presence tuple 104.

As discussed above, the policy tuple manager 102 can be configured for receiving a policy specification that specifies binding-related information for invoking an action. The binding-related information may be provided by a binding generator (not shown) in the policy handler 100 or separate from the policy handler 100.

The policy handler 100 also includes means for determining when the condition associated with the specified tuple 112 is met. For example, when the policy watcher 106 detects a change in a watched tuple 112 associated with a policy tuple 104, the policy handler 100 along with user provided element code parses the policy tuple 104, detects a specified condition, and determines if the condition is met using available information which typically includes information associated with the watched tuple 104. Other means can be used to provide equivalent function, including any of the means discussed above, such as by subscribing to a tuple in receiving a notify message when the tuple 112 is updated. The policy watcher 106 is not necessarily required to use a pub/sub protocol to determine when the condition is met.

The policy handler 100 also includes means for invoking the associated action. For example, the policy action initiator 108 can be configured for invoking a local policy enforcement function 400 for performing the associated action using any known communication means. Alternatively, the policy action initiator 108 can be configured for sending a notify message using a pub/sub protocol to a remote policy enforcer 122 for performing the action, as discussed above with reference to FIG. 1.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

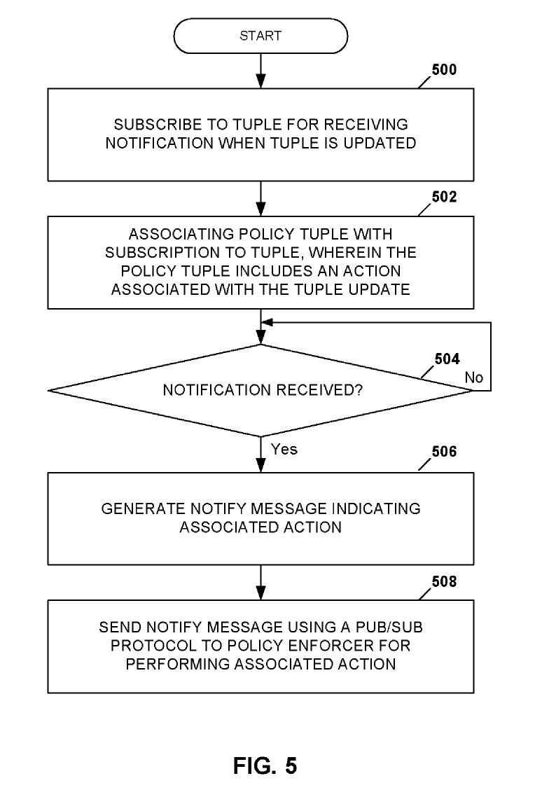

FIG. 5 is a flow diagram illustrating a method for associating policies with tuples using a pub/sub protocol according to an aspect of the subject matter disclosed herein. In block 500, a tuple 112 is subscribed to for receiving a notification when the tuple 112 is updated. For example, the tuple 112 can be subscribed to using a pub/sub protocol. In another example, a policy tuple can be subscribed to.

A policy tuple 104 is associated with the subscription to the tuple 112 in block 502. For example, a policy tuple 104 that is a presence tuple can be associated with the subscription and/or a policy tuple 104 that is a subtuple of the tuple 112 can be associated with the subscription. In addition, the policy tuple can be associated with a watcher that is watching the tuple 112, such as the policy watcher 106. The policy tuple 104 identifies an action associated with the tuple update or other tuple event.

In block 504, the policy handler 100 determines whether the notification has been received. When the policy handler 100 determines that the notification is received, a notify message indicating the associated action is generated by the policy handler 100 in block 506 and, in block 508, the notify message is sent using a pub/sub protocol to a policy enforcer for performing the associated action. For example, the generated notify message can include an action identifier for the associated action, can identify the policy enforcer for performing the associated action, can include binding-related information for enabling the invoking of the associated action, and/or can indicate that the associated action should be performed on the tuple 112.

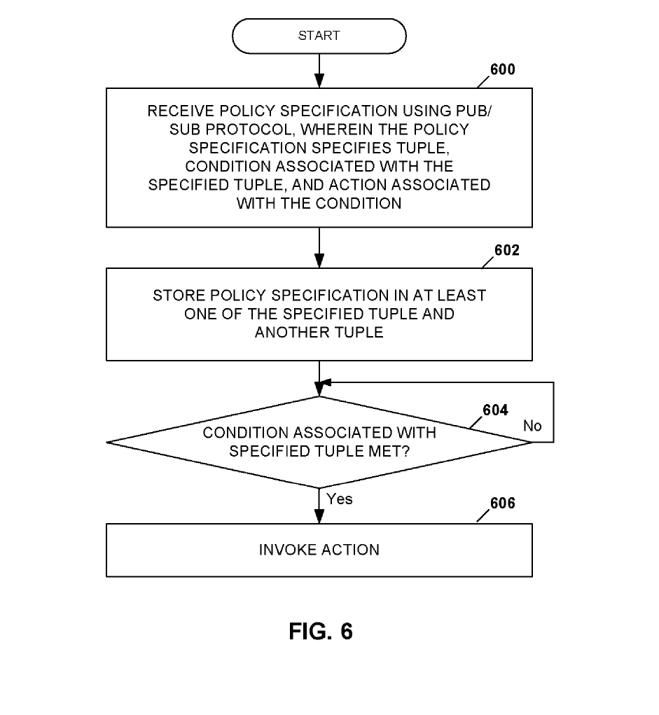

FIG. 6 is a flow diagram illustrating a method for associating policies with tuples using a pub/sub protocol according to another aspect of the subject matter disclosed herein. A policy specification is received using a pub/sub protocol in block 600. The policy specification specifies a tuple 112, a condition associated with the specified tuple 112, and an action associated with the condition. For example, receiving a policy specification using a pub/sub protocol can include receiving a policy specification that specifies a presence tuple, a condition associated with the presence tuple, and an action associated with the condition, according to one aspect. According to another aspect, receiving a policy specification using a pub/sub protocol can include receiving a policy specification that specifies a policy tuple, a condition associated with the policy tuple, and an action associated with the condition. Receiving a policy specification using a pub/sub protocol can include receiving a policy specification that specifies binding-related information for invoking the associated action, according to yet another aspect.

In block 602, the policy specification is stored in at least one of the specified tuple and another tuple. For example, the policy specification can be stored in a subtuple of the specified tuple and/or in a presence tuple.

In block 604, the policy handler 100 determines when the condition associated with the specified tuple is met. For example, the policy handler 100 can watch the specified tuple using a watcher associated with the policy tuple to determine when the condition associated with the specified tuple is met.

In response to determining that the condition is met in block 604, the action is invoked in block 606. For example, invoking the action can include invoking a local policy enforcement function 400 to perform the action and/or can include sending a notify message using a pub/sub protocol to a remote policy enforcer 122 for performing the action.

Several scenarios that illustrate associating policies with tuples using a pub/sub protocol are listed below:
Scenario 1: Archive and remove a tuple for a buy/sell transaction at end of transaction:
   Anna browses OldClothes.com looking for vintage clothing through her presence browser. She publishes a request to buy a particular item to a tuple.
   The transaction involves verifying whether the item is in stock, placing a request to the specified shipper and getting a pickup date/time, and authorizing payment with her credit card company.
   At the completion of the transaction, a policy watcher detects that the transaction status matches a configured condition in a policy tuple associated with the request. The policy watcher invokes the configured action handler, which logs the transaction data in a log file and deletes all the tuples associated with the transaction.
Scenario 2: Create a new tuple using default values requiring client to provide minimal initial information:
   Anna publishes a new tuple using a new service she owns and is providing to selected users. She provides basic information.
   The policy tuple for this type of service provides information for default values for owner information and contact information, and creates an empty access list (a roster).
   A condition that matches tuple creation and empty access list causes an action to be invoked that presents Anna with a user interface to allow her to populate the access list.
Scenario 3: Use policy tuple to manage work-flow process:
   Anna manages the vacation request process at the Bedrock Quarry. Currently when an employee submits a request, it is routed to his/her manager with no notifications being sent to anyone else.
   Anna updates the current policy tuple for vacation requests that have a status of “new”. She uses a lookup action to determine the employee's project manager(s), followed by a send action to send the request to the project manager(s) for approval, along with an action to send a notification of the request to the employee's manager, and finally specifies an action that updates the vacation tuple's status to pending.
   She reworks the rest of the approval process through further configuration of the tuple.
Scenario 4: Policy-tuple used for processing of request tuple. Request tuple contains only request data: (e.g., policy tuple may preprocess request, redirect request, filter/reject request, perform data validation, and/or perform service specific security checks)
   Joe submits a request to order a Ferrari from Apex Ferrari.
   The Policy-tuple for Apex Ferrari's request tuples has a condition set to match new requests with price >=$100,000.
   The matching actions includes a user supplied action to order a credit report for the buyer, send a message to the buyer that a credit report is being requested, contact the buyer for any needed info, and update the request status to “credit check pending” before the request notification is sent to the dealer's server for handling.

The subject matter described herein allows many tuple operations to be automated, requiring less work for the user. Condition/action associations can be stored in policy tuples, thus allowing them to be managed using the same server, clients, and protocols as other tuples. Structured relationships can be created among policies, such as a hierarchy of policy tuples, to automate the monitoring and management of their associated tuples. In addition, tuple processing can be separated from tuple data by separating the policy data and the carrying out of the associated actions.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for associating policies with tuples using a pub/sub protocol, the method comprising:
subscribing to a tuple for receiving a notification when the tuple is updated;
associating a policy tuple with the subscription to the tuple, wherein the policy tuple identifies an action associated with the tuple update; and
responsive to receiving the notification:
generating a notify message indicating the associated action; and
sending the notify message using a pub/sub protocol to a policy enforcer for performing the associated action.

2. The method of claim 1 wherein subscribing to a tuple for receiving a notification when the tuple is updated includes subscribing to a tuple using a pub/sub protocol.

3. The method of claim 1 wherein subscribing to a tuple for receiving a notification when the tuple is updated includes subscribing to a policy tuple.

4. The method of claim 1 wherein associating a policy tuple with the subscription to the tuple includes associating a presence tuple with the subscription.

5. The method of claim 1 wherein associating a policy tuple with the subscription to the tuple includes associating a policy tuple that is a subtuple of the tuple.

6. The method of claim 1 wherein associating a policy tuple with the subscription to the tuple includes associating the policy tuple with a watcher that is watching the tuple.

7. The method of claim 1 wherein generating a notify message indicating the associated action includes generating a notify message that includes an action identifier for the associated action.

8. The method of claim 1 wherein generating a notify message indicating the associated action includes generating a notify message that identifies the policy enforcer for performing with the associated action.

9. The method of claim 1 wherein generating a notify message indicating the associated action includes generating a notify message that identifies binding-related information for invoking the associated action.

10. The method of claim 1 wherein generating a notify message indicating the associated action includes generating a notify message indicating that the associated action should be performed on the tuple.

11. A method for associating policies with tuples using a pub/sub protocol, the method comprising:
receiving a policy specification using a pub/sub protocol, wherein the policy specification specifies a tuple, a condition associated with the specified tuple, and an action associated with the condition;
storing the policy specification in at least one of the specified tuple and another tuple;
determining when the condition associated with the specified tuple is met; and
responsive to determining that the condition is met, invoking the action.

12. The method of claim 11 wherein receiving a policy specification using a pub/sub protocol includes receiving a policy specification that specifies a presence tuple, a condition associated with the presence tuple, and an action associated with the condition.

13. The method of claim 11 wherein receiving a policy specification using a pub/sub protocol includes receiving a policy specification that specifies a policy tuple, a condition associated with the policy tuple, and an action associated with the condition.

14. The method of claim 11 wherein receiving a policy specification using a pub/sub protocol includes receiving a policy specification that specifies binding-related information for invoking the associated action.

15. The method of claim 11 wherein storing the policy specification in at least one of the specified tuple and another tuple includes storing the policy specification in a subtuple of the specified tuple.

16. The method of claim 11 wherein storing the policy specification in at least one of the specified tuple and another tuple includes storing the policy specification in a presence tuple.

17. The method of claim 11 wherein determining when the condition associated with the specified tuple is met includes watching the specified tuple using a watcher associated with the policy tuple.

18. The method of claim 11 wherein invoking the action includes invoking a local policy enforcement function to perform the action.

19. The method of claim 11 wherein invoking the action includes sending a notify message using a pub/sub protocol to a remote policy enforcer for performing the action.

20. A computer program product comprising computer executable instructions embodied in a computer-readable medium for performing steps comprising:
subscribing to a tuple for receiving a notification when the tuple is updated;
associating a policy tuple with the subscription to the tuple, wherein the policy tuple identifies an action associated with the tuple update; and
responsive to receiving the notification:
generating a notify message indicating the associated action; and
sending the notify message using a pub/sub protocol to a policy enforcer for performing the associated action.

21. A computer program product comprising computer executable instructions embodied in a computer-readable medium for performing steps comprising:
receiving a policy specification using a pub/sub protocol, wherein the policy specification specifies a tuple, a condition associated with the specified tuple, and an action associated with the condition;
storing the policy specification in at least one of the specified tuple and another tuple;
determining when the condition associated with the specified tuple is met; and
responsive to determining that the condition is met, invoking the action.

22. A system for associating policies with tuples using a pub/sub protocol, comprising:
means for storing a policy specification as a policy tuple that specifies a tuple, a condition associated with the specified tuple, and an action associated with the condition;
means for subscribing to the tuple for receiving a notification when the tuple is updated, for associating the policy tuple with the subscription to the tuple, and for determining if the tuple update satisfies the condition associated with the tuple based on the tuple update notification; and
means for generating, responsive to receiving the notification, a notify message indicating the associated action and for sending the notify message using a pub/sub protocol to a policy enforcer for performing the associated action.

23. A system for associating policies with tuples using a pub/sub protocol, comprising:
a policy tuple manager configured for storing a policy specification as a policy tuple that specifies a tuple, a condition associated with the specified tuple, and an action associated with the condition;
a policy watcher configured for subscribing to the tuple for receiving a notification when the tuple is updated, for associating the policy tuple with the subscription to the tuple, and for determining if the tuple update satisfies the condition associated with the tuple based on the tuple update notification; and
a policy action initiator configured for generating, responsive to receiving the notification, a notify message indicating the associated action and for sending the notify message using a pub/sub protocol to a policy enforcer for performing the associated action.

24. The system of claim 23 wherein the policy tuple manager is configured for storing the policy specification as a presence tuple.

25. The system of claim 23 wherein the policy tuple manager is configured for storing the policy specification a subtuple of the specified tuple.

26. The system of claim 23 wherein the specified tuple is a policy tuple.

27. The system of claim 23 wherein the policy watcher is configured for subscribing to the specified tuple using a pub/sub protocol.

28. The system of claim 23 wherein the policy action initiator is configured for generating a notify message that includes an action identifier for the associated action.

29. The system of claim 23 wherein the policy action initiator is configured for generating a notify message that identifies the policy enforcer for performing with the associated action.

30. The system of claim 23 wherein the policy action initiator is configured for generating a notify message that identifies binding-related information for invoking the associated action.

31. The system of claim 23 wherein the policy action initiator is configured for generating a notify message indicating that the associated action should be performed on the specified tuple.

32. A system for associating policies with tuples using a pub/sub protocol, comprising:
means for receiving a policy specification using a pub/sub protocol and for storing the policy specification as a policy tuple that specifies a tuple, a condition associated with the specified tuple, and an action associated with the condition;
means for determining when the condition associated with the specified tuple is met; and
means for invoking the associated action.

33. A system for associating policies with tuples using a pub/sub protocol, comprising:
a policy tuple manager configured for receiving a policy specification using a pub/sub protocol and for storing the policy specification as a policy tuple that specifies a tuple, a condition associated with the specified tuple, and an action associated with the condition;
a policy watcher configured for determining when the condition associated with the specified tuple is met; and
a policy action initiator configured for invoking the associated action.

34. The system of claim 33 wherein the policy tuple manager is configured for storing the policy specification as a policy tuple that specifies a presence tuple, a condition associated with the presence tuple, and an action associated with the condition.

35. The system of claim 33 wherein the policy tuple manager is configured for storing the policy specification as a policy tuple that specifies another policy tuple, a condition associated with the other policy tuple, and an action associated with the condition.

36. The system of claim 33 wherein the policy tuple manager is configured for receiving a policy specification that specifies binding-related information for invoking the associated action.

37. The system of claim 33 wherein the policy tuple manager is configured for storing the policy specification in a subtuple of the specified tuple.

38. The system of claim 33 wherein the policy tuple manager is configured for storing the policy specification in a presence tuple.

39. The system of claim 33 wherein the policy action initiator is configured for invoking a local policy enforcement function to perform the action.

40. The system of claim 33 wherein the policy action initiator is configured for sending a notify message using a pub/sub protocol to a remote policy enforcer for performing the action.
